(19) United States
(12) Patent Application Publication
(10) Pub. No.: US 2020/0096000 A1
(43) Pub. Date: Mar. 26, 2020

(54) BLOWER APPARATUS

(71) Applicant: Nidec Corporation, Kyoto (JP)

(72) Inventors: Guiling ZHANG, Kyoto (JP); Hidenobu TAKESHITA, Kyoto (JP)

(21) Appl. No.: 16/574,198

(22) Filed: Sep. 18, 2019

(30) Foreign Application Priority Data
Sep. 25, 2018 (JP) 2018-178999

(51) Int. Cl. F04D 25/06; H02K 7/14; F04D 19/00

(52) U.S. Cl. CPC F04D 25/0606; F04D 19/002; H02K 7/14

(57) ABSTRACT

A blower apparatus includes a casing that houses a first impeller, a first motor, a first circuit board, a second impeller, a second motor, and a second circuit board, a motor housing integrally provided with the casing, a first housing that supports the first motor, and a second housing that supports the second motor. The first housing or the second housing includes a first recessed portion into which a mounted component on the first circuit board is inserted from a first side in the axial direction, and a second recessed portion into which a mounted component on the second circuit board is inserted from a second side in the axial direction. In the first housing or the second housing, the first recessed portion and the second recessed portion are offset from each other in at least one of the circumferential direction and the radial direction.

### CROSS REFERENCE TO RELATED APPLICATION

The present invention claims priority under 35 U.S.C. § 119 to Japanese Application No. 2018-178999 filed on Sep. 25, 2018, the entire contents of which are hereby incorporated herein by reference.

### 1. FIELD OF THE INVENTION

The present disclosure relates to a blower apparatus including two impellers arranged in the axial direction.

### 2. BACKGROUND

Conventionally, a known blower apparatus is constructed by connecting a first casing and a second casing. The first casing houses a first impeller and a first motor. The second casing houses a second impeller and a second motor. When the first casing and the second casing are connected, the first impeller and the second impeller are axially aligned such that central axes serving as rotation centers are coaxial.

An intake port is provided on one side (for example, the upper side) in the axial direction of the first casing. A plurality of first ribs arranged in the circumferential direction are provided on the other side (for example, the lower side) of the first casing in the axial direction. First openings are formed between the circumferentially adjacent first ribs. A first support frame is provided radially inward of the plurality of first ribs. The first support frame supports the first motor.

A plurality of second ribs arranged in the circumferential direction are provided on one side (for example, the upper side) of the second casing in the axial direction. A discharge port is provided on the other side (for example, the lower side) of the second casing in the axial direction. Second openings are formed between the circumferentially adjacent second ribs. A second support frame is provided radially inward of the plurality of second ribs. The second support frame supports the second motor.

When the first impeller and the second impeller are respectively rotated by the first motor and the second motor, air is sucked into the interior of the first casing through the intake port. The sucked air flows toward the discharge port sequentially through the first openings and the second openings, and is discharged to the outside through the discharge port.

The rotation direction of the second impeller is opposite to the rotation direction of the first impeller. The orientations of blades of the first impeller and the second impeller are set such that, when the first impeller and the second impeller are rotated, the air flows from the intake port to the discharge port in the first casing and the second casing.

Further, a first circuit board for driving the first motor is accommodated in the first casing. The first circuit board is located on the side (second impeller side) opposite to the intake port with respect to the first impeller in the first casing. Further, a second circuit board for driving the second motor is accommodated in the second casing. The second circuit board is located on the side (first impeller side) opposite to the discharge port with respect to the second impeller in the second casing.

The first support frame is provided with a first recessed part. A mounted component on the first circuit board is inserted into the first recessed part. Similarly, the second support frame is provided with a second recessed part. A mounted component on the second circuit board is inserted into the second recessed part.

Meanwhile, a demand for thickness reduction of a blower apparatus has been recently increasing. In order to reduce the thickness of the blower apparatus, it is necessary to reduce the thickness of a casing. To this end, it is necessary to decrease the axial distance between the first impeller and the second impeller by decreasing the axial distance between the first circuit board and the second circuit board, for example. In order to shorten the axial distance between the first circuit board and the second circuit board, it is necessary to reduce the first support frame and the second support frame in thickness, for example.

However, in the configuration described above, the first recessed part and the second recessed part are at the same position in the circumferential direction and the radial direction. Therefore, it becomes difficult to reduce the first support frame and the second support frame in thickness to decrease the axial distance between the first circuit board and the second circuit board. That is, when the first support frame and the second support frame are reduced in thickness in the case where the first recessed part and the second recessed part are at the same position in the circumferential direction and the radial direction, the first recessed part and the second recessed part may pass through the first support frame and the second support frame in the axial direction. When the first recessed part and the second recessed part pass through the first support frame and the second support frame in the axial direction, the mounted component on the first circuit board and the mounted component on the second circuit board interfere with each other, making it difficult to ensure electrical insulation. As a result, it may be difficult to reduce the thickness of the blower apparatus.

### SUMMARY

A blower apparatus according to an example embodiment of the present disclosure includes a first impeller and a second impeller that are arranged in an axial direction, a first motor closer to the second impeller than to the first impeller to rotate the first impeller around a central axis, a first circuit board closer to the second impeller than to the first impeller on the first motor, a second motor closer to the first impeller than to the second impeller to rotate the second impeller around the central axis, a second circuit board closer to the first impeller on the second motor than to the second impeller, a casing that houses the first impeller, the first motor, the first circuit board, the second impeller, the second motor, and the second circuit board, a motor housing that is located between the first impeller and the second impeller in the casing, that is located radially inward of the casing, and that is integrally provided with the casing, a first housing that supports the first motor on a first side in the axial direction of the motor housing, and a second housing that supports the second motor on a second side in the axial direction of the motor housing. The first housing or the second housing includes a first recessed portion which is open on the first side in the axial direction, which is closed on the second side in the axial direction, and into which a mounted component on the first circuit board is inserted from the first side in the axial direction, and a second recessed portion which is open on the second side in the axial direction, which is closed on the first side in the axial direction, and into which a mounted component on the second circuit board is inserted from the second side in the axial direction, the first recessed portion and the second recessed portion being offset from each other in at least one of a circumferential direction and a radial direction in the first housing or the second housing.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a perspective view of a blower apparatus according to an example embodiment of the present disclosure as viewed from an intake port side.

FIG. 2 is a perspective view of a configuration of a portion of the inside of a casing of the blower apparatus as viewed from the intake port side.

FIG. 3 is a perspective view of the blower apparatus as viewed from a discharge port side.

FIG. 4 is a perspective view of a configuration of a portion of the inside of the casing of the blower apparatus as viewed from the discharge port side.

FIG. 5 is a longitudinal sectional view of the blower apparatus.

FIG. 6 is an exploded sectional view of a first housing and a second housing of the blower apparatus.

FIG. 7 is a plan view of the first housing of the blower apparatus as viewed from the intake port side.

FIG. 8 is a sectional view showing a desired positional relationship between a first circuit board and a second circuit board.

FIG. 9 is a longitudinal sectional view showing a configuration of a blower apparatus according to another example embodiment of the present disclosure.

FIG. 10 is an exploded sectional view of a motor housing, a first housing, and a second housing of the blower apparatus.

FIG. 11 is an exploded sectional view showing another configuration of the motor housing and the second housing.

FIG. 12 is an exploded sectional view showing another configuration of the first housing and the second housing.

FIG. 13 is an exploded sectional view showing another configuration of the first housing and the second housing.

### DETAILED DESCRIPTION

Hereinafter, example embodiments of the present disclosure will be described in detail with reference to the accompanying drawings. It is assumed herein that: an axis serving as a rotation center of a first impeller and a second impeller is referred to as a “central axis”; and the direction in which the central axis extends is referred to by the term “axial direction”, “axial”, or “axially”. In addition, directions perpendicular to the central axis with respect to the central axis are each referred to simply by the term “radial direction”, “radial”, or “radially”. In this regard, in the radial direction, the side closer to the central axis is referred to by the term “radially inner side” or “radially inward”, and the side farther from the central axis is referred to by the term “radially outer side” or “radially outward”. Further, a direction along a circular arc around the central axis is referred to by the term “circumferential direction”, “circumferential”, or “circumferentially”.

It is also assumed herein that, for the sake of convenience of description, an axial direction is defined as a vertical direction, and the shape of each member or part and relative positions of different members or parts will be described on the assumption that a vertical direction of the blower apparatus corresponds to the vertical direction of the axial direction. In this regard, one of the directions of the axis is referred to by the term “upper” or “top”, and the other direction of the axis is referred to by the term “lower” or “bottom”. Further, one side in the axial direction is referred to by the term “axially above”, “above in the axial direction”, or “upper side in the axial direction”, and the another side in the axial direction is referred to by the term “axially below”, “below in the axial direction” or “lower side in the axial direction”. It should be noted, however, that the above definition of the vertical direction is not intended to restrict the orientation of, or relative positions of different members or parts of, the blower apparatus when in use.

It is also assumed herein that a section parallel to the axial direction is referred to as a “longitudinal section”. Note that the wording “parallel” as used herein includes not only “exactly parallel” but also “substantially parallel”.

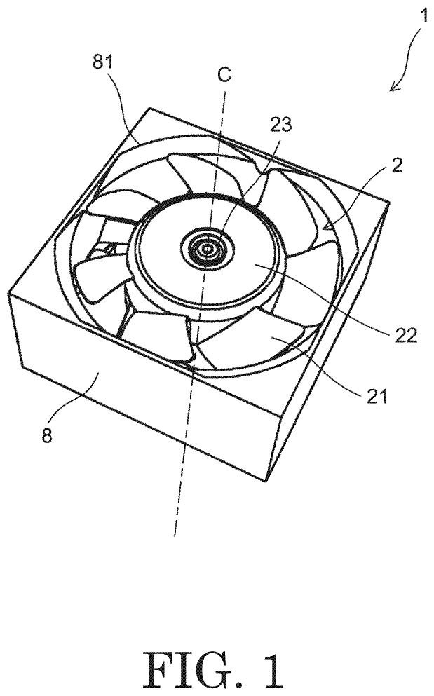

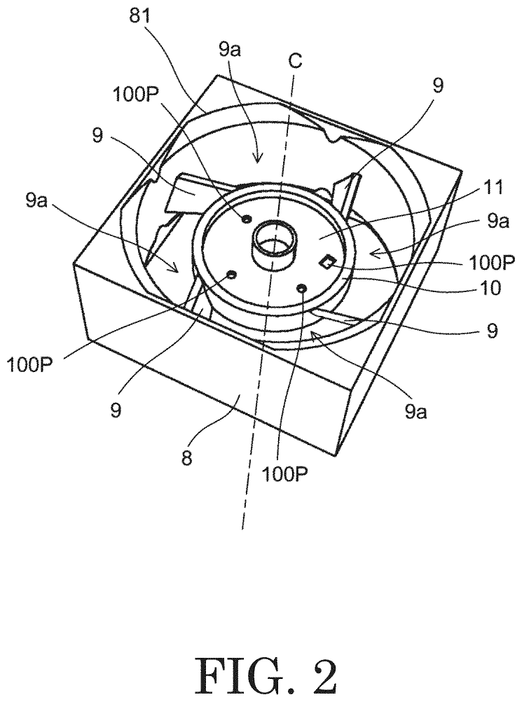

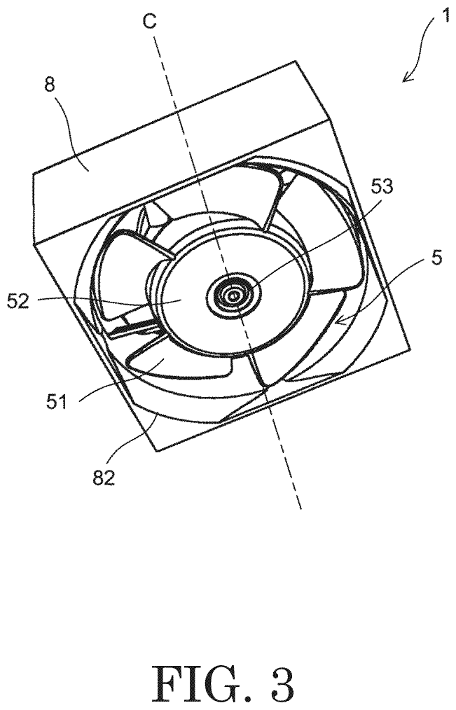

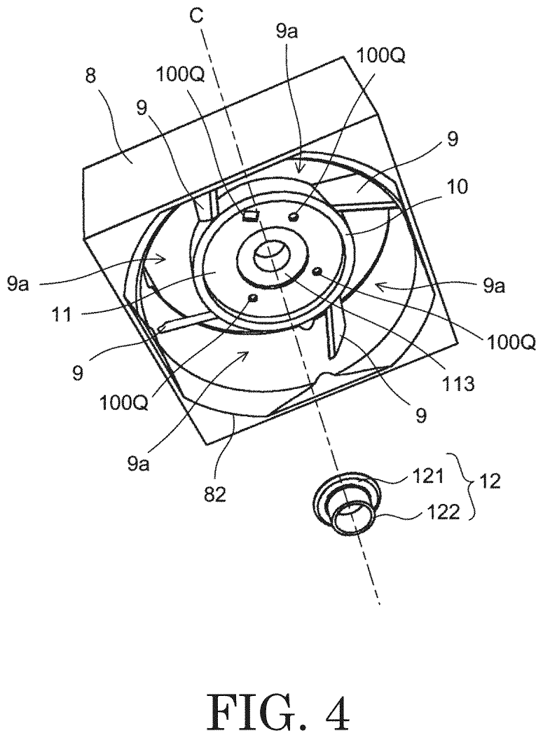

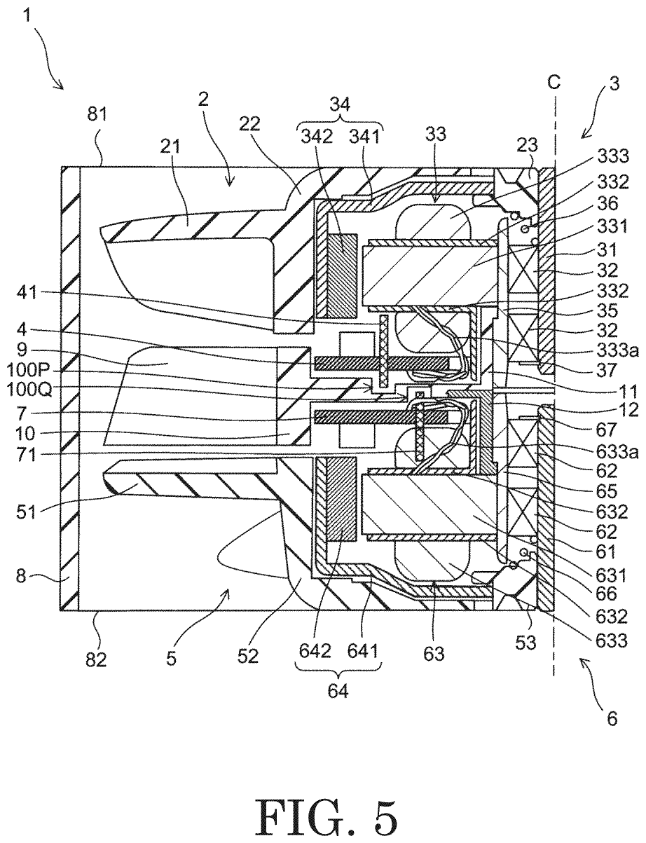

FIG. 1 is a perspective view of a blower apparatus 1 according to an example embodiment of the present disclosure as viewed from an intake port 81 side. FIG. 2 is a perspective view of the configuration of a part of the inside of a casing 8 of the blower apparatus 1 as viewed from the intake port 81 side. FIG. 3 is a perspective view of the blower apparatus 1 as viewed from a discharge port 82 side. FIG. 4 is a perspective view of the configuration of a part of the inside of the casing 8 of the blower apparatus 1 as viewed from the discharge port 82 side. FIG. 5 is a longitudinal sectional view of the blower apparatus 1. For convenience, FIG. 5 shows the cross section of only one side of the blower apparatus 1 in the radial direction with respect to the central axis C.

The blower apparatus 1 is a counter-rotating blower apparatus. Specifically, the blower apparatus 1 includes a first impeller 2, a first motor 3, a first circuit board 4, a second impeller 5, a second motor 6, a second circuit board 7, the casing 8, a plurality of ribs 9, a motor housing 10, a first housing 11, and a second housing 12. The casing 8, the plurality of ribs 9, the motor housing 10, the first housing 11, and the second housing 12 are formed of, for example, resin.

The first impeller 2 is disposed axially above and radially outward of the first motor 3 in the casing 8. The first impeller 2 is rotated about the central axis C by the first motor 3. The first impeller 2 is located axially above the second impeller 5.

The first impeller 2 has a first impeller cup 22, a plurality of first blades 21, and a first fixing unit 23. The first impeller cup 22 is fixed to the first motor 3 via the first fixing unit 23. The first impeller cup 22 is a substantially cylindrical member having a lid on the upper side in the axial direction. A rotor yoke 341 of the first motor 3 is fixed to the inside of the first impeller cup 22.

The plurality of first blades 21 are circumferentially arranged on the outer surface of the first impeller cup 22. In the present example embodiment, the first impeller 2 has seven first blades 21 as shown in FIG. 1, but the number of first blades 21 is not limited to seven. The first fixing unit 23 is a member for fixing the first impeller cup 22 to a first shaft 31 of the first motor 3.

The first motor 3 is located axially below the first impeller 2 in the casing 8. The first motor 3 rotates the first impeller 2 about the central axis C. That is, the blower apparatus 1 includes the first motor 3 that is located closer to the second impeller 5 than to the first impeller 2 and rotates the first impeller 2 around the central axis C. The first motor 3 has the first shaft 31, a first bearing 32, a first stator 33, a first rotor 34, and a first bearing holding unit 35.

The first shaft 31 is arranged to extend along the central axis C. The first shaft 31 is, for example, a columnar member which is made of metal such as stainless steel, and extends in the axial direction. The first shaft 31 is rotatably supported about the central axis C by the first bearing 32. The first shaft 31 is urged upward in the axial direction by a first spring 36 via the first fixing unit 23 with respect to the uppermost first bearing 32 in the axial direction. Thus, the downward movement of the first shaft 31 in the axial direction is suppressed. In addition, a first C retaining ring 37 is attached near the axially lower end of the first shaft 31. This prevents dislodgement of the first shaft 31 toward the upper side in the axial direction.

The first bearing 32 is held radially inward of the first bearing holding unit 35 which is cylindrical around the central axis C, and rotatably supports the first shaft 31 around the central axis C. The first bearing 32 is, for example, a ball bearing, but may be a sleeve bearing or the like.

The first bearing holding unit 35 is made of metal such as stainless steel or resin. When the first bearing holding unit 35 is made of metal, the first bearing holding unit 35 may be integrally formed with the first housing 11 by, for example, insert molding. On the other hand, when the first bearing holding unit 35 is made of resin, the first bearing holding unit 35 may be integrally formed with the first housing 11 by injection molding. Alternatively, the first bearing holding unit 35 and the first housing 11 may be connected by another method such as press-fitting or adhesion using an adhesive.

The first stator 33 is fixed to the outer circumferential surface of the first bearing holding unit 35. The first stator 33 includes a stator core 331, an insulator 332, and a coil 333.

The stator core 331 is formed by laminating electromagnetic steel plates such as silicon steel plates in the vertical direction. The insulator 332 is made of an insulating resin. The insulator 332 is provided to surround the outer surface of the stator core 331. The coil 333 is composed of a conducting wire wound around the stator core 331 via the insulator 332.

The first rotor 34 is disposed axially above and radially outward of the first stator 33. The first rotor 34 rotates around the central axis C with respect to the first stator 33. The first rotor 34 has the rotor yoke 341 and a magnet 342.

The rotor yoke 341 is a substantially cylindrical member that is made of a magnetic material and has a lid on the upper side in the axial direction. The rotor yoke 341 is fixed to the first shaft 31 via the first fixing unit 23. The magnet 342 has a cylindrical shape and is fixed to the inner circumferential surface of the rotor yoke 341. The magnet 342 is disposed radially outward of the first stator 33.

The first circuit board 4 is disposed on the lower side of the first motor 3 in the axial direction in the casing 8. That is, the blower apparatus 1 has the first circuit board 4 provided on the second impeller 5 side of the first motor 3. The first circuit board 4 has a disk shape extending in the radial direction about the central axis C, and is provided to drive the first motor 3. The first circuit board 4 is held by the first motor 3 via the insulator 332.

An electronic circuit for supplying a drive current to the coil 333 is mounted on the first circuit board 4 so as to be electrically connected to a lead wire 333a of the coil 333. The electronic circuit includes electronic components such as a capacitor and a resistor. The first circuit board 4 is also mounted with a Hall element for detecting the rotational position of the first rotor 34 and a component such as a binding pin around which the lead wire 333a is wound and held as necessary. Hereinafter, various components mounted on the first circuit board 4 will be referred to as mounted components 41.

The second impeller 5 is positioned in the casing 8 so as to be aligned with the first impeller 2 in the axial direction. That is, the blower apparatus 1 has the first impeller 2 and the second impeller 5 which are arranged in the axial direction. The second impeller 5 is disposed axially below and radially outward of the second motor 6. The second impeller 5 is rotated about the central axis C by the second motor 6.

The second impeller 5 has a second impeller cup 52, a plurality of second blades 51, and a second fixing unit 53. The second impeller cup 52 is fixed to the second motor 6 via the second fixing unit 53. The second impeller cup 52 is a substantially cylindrical member having a lid on the lower side in the axial direction. A rotor yoke 641 of the second motor 6 is fixed to the inside of the second impeller cup 52.

The plurality of second blades 51 are circumferentially arranged on the outer surface of the second impeller cup 52. In the present example embodiment, the second impeller 5 has five second blades 51 as shown in FIG. 3, but the number of second blades 51 is not limited to five. The second fixing unit 53 is a member for fixing the second impeller cup 52 to a second shaft 61 of the second motor 6.

The second motor 6 is located axially above the second impeller 5 in the casing 8. The second motor 6 rotates the second impeller 5 about the central axis C. That is, the blower apparatus 1 includes the second motor 6 that is located closer to the first impeller 2 than to the second impeller 5 and rotates the second impeller 5 around the central axis C. The second motor 6 has the second shaft 61, a second bearing 62, a second stator 63, a second rotor 64, and a second bearing holding unit 65.

The second shaft 61 is arranged to extend along the central axis C. The second shaft 61 is, for example, a columnar member which is made of metal such as stainless steel, and extends in the axial direction. The second shaft 61 is rotatably supported about the central axis C by the second bearing 62. The second shaft 61 is urged downward in the axial direction by a second spring 66 via the second fixing unit 53 with respect to the lowermost second bearing 62. Thus, the upward movement of the second shaft 61 in the axial direction is suppressed. In addition, a second C retaining ring 67 is attached near the axially upper end of the second shaft 61. This prevents dislodgement of the second shaft 61 toward the lower side in the axial direction.

The second bearing 62 is held radially inward of the second bearing holding unit 65 which is cylindrical around the central axis C, and rotatably supports the second shaft 61 around the central axis C. The second bearing 62 is, for example, a ball bearing, but may be a sleeve bearing or the like.

The second bearing holding unit 65 is made of metal such as stainless steel or resin. When the second bearing holding unit 65 is made of metal, the second bearing holding unit 65 may be integrally formed with the second housing 12 by insert molding. On the other hand, when the second bearing holding unit 65 is made of resin, the second bearing holding unit 65 may be integrally formed with the second housing 12 by injection molding. Alternatively, the second bearing holding unit 65 and the second housing 12 may be connected by another method such as press-fitting or adhesion using an adhesive.

The second stator 63 is fixed to the outer circumferential surface of the second bearing holding unit 65. The second stator 63 includes a stator core 631, an insulator 632, and a coil 633.

The stator core 631 is formed by laminating electromagnetic steel plates such as silicon steel plates in the vertical direction. The insulator 632 is made of an insulating resin. The insulator 632 is provided to surround the outer surface of the stator core 631. The coil 633 is composed of a conducting wire wound around the stator core 631 via the insulator 632.

The second rotor 64 is disposed axially below and radially outward of the second stator 63. The second rotor 64 rotates around the central axis C with respect to the second stator 63. The second rotor 64 has a rotor yoke 641 and a magnet 642.

The rotor yoke 641 is a substantially cylindrical member made of a magnetic material and having a lid on the lower side in the axial direction. The rotor yoke 641 is fixed to the second shaft 61 via the second fixing unit 53. The magnet 642 is cylindrical and fixed to the inner circumferential surface of the rotor yoke 641. The magnet 642 is disposed radially outward of the second stator 63.

The second circuit board 7 is disposed on the upper side of the second motor 6 in the axial direction in the casing 8. That is, the blower apparatus 1 has the second circuit board 7 provided on the first impeller 2 side of the second motor 6. The second circuit board 7 has a disk shape extending in the radial direction about the central axis C, and is provided to drive the second motor 6. The second circuit board 7 is held by the second motor 6 via the insulator 632.

An electronic circuit for supplying a drive current to the coil 633 is mounted on the second circuit board 7 so as to be electrically connected to a lead wire 633a of the coil 633. The electronic circuit includes electronic components such as a capacitor and a resistor. The second circuit board 7 is also mounted with a Hall element for detecting the rotational position of the second rotor 64 and a component such as a binding pin around which the lead wire 633a is wound and held as necessary. Hereinafter, various components mounted on the second circuit board 7 will be referred to as mounted components 71.

The casing 8 houses inside the above-described first impeller 2 and the like. That is, the blower apparatus 1 has the casing 8 which houses inside the first impeller 2, the first motor 3, the first circuit board 4, the second impeller 5, the second motor 6, and the second circuit board 7. In the present example embodiment, the casing 8 has a unitary structure, and is not constructed by bonding separate casings.

The casing 8 has an intake port 81 and a discharge port 82. The intake port 81 is an opening for taking in external air into the casing 8. The intake port 81 is positioned on the upper side of the casing 8 in the axial direction. The discharge port 82 is an opening for discharging the air in the casing 8 to the outside. The discharge port 82 is positioned on the lower side of the casing 8 in the axial direction.

The plurality of ribs 9 are positioned radially inward of the casing 8. The plurality of ribs 9 are located substantially at the center of the casing 8 in the axial direction. The ribs 9 are arranged in the circumferential direction with opening 9a therebetween. The opening 9a is a hole through which air flowing from the intake port 81 to the discharge port 82 in the casing 8 passes when the first impeller 2 and the second impeller 5 rotate. Each rib 9 is integrally formed with the casing 8.

The motor housing 10 is located between the first impeller 2 and the second impeller 5 in the casing 8. The motor housing 10 is located radially inward of the plurality of ribs 9 in the casing 8 and is formed so as to surround the central axis C. The motor housing 10 is formed integral with the plurality of ribs 9 and supported to the casing 8 by the plurality of ribs 9. Therefore, the motor housing 10 is integrally formed with the casing 8 via the plurality of ribs 9. That is, the blower apparatus 1 has the motor housing 10 which is located between the first impeller 2 and the second impeller 5 in the casing 8, is located radially inward with respect to the casing 8, and integrally formed with the casing 8.

The first housing 11 supports the first motor 3 on the upper side of the motor housing 10 in the casing 8. That is, the blower apparatus 1 has the first housing 11 which supports the first motor 3 on one side of the motor housing 10 in the axial direction. The first housing 11 is located radially inward of the motor housing 10. In the present example embodiment, the first housing 11 is integrally formed with the motor housing 10.

The second housing 12 supports the second motor 6 on the lower side of the motor housing 10 in the casing 8. That is, the blower apparatus 1 has the second housing 12 which supports the second motor 6 on the another side of the motor housing 10 in the axial direction. The details of the first housing 11 and the second housing 12 will be described later.

In the above configuration, when a drive current is supplied from the first circuit board 4 to the coil 333 of the first motor 3, a magnetic flux in the radial direction is generated in the stator core 331. A magnetic field generated by the magnetic flux of the stator core 331 and a magnetic field generated by the magnet 342 act to generate torque in the circumferential direction of the first rotor 34. The generated torque causes the first rotor 34 and the first impeller 2 to rotate about the central axis C together with the first shaft 31.

In addition, when the drive current is supplied from the second circuit board 7 to the coil 633 of the second motor 6, a magnetic flux in the radial direction is generated in the stator core 631. A magnetic field generated by the magnetic flux of the stator core 631 and a magnetic field generated by the magnet 642 act to generate torque in the circumferential direction of the second rotor 64. The generated torque causes the second rotor 64 and the second impeller 5 to rotate about the central axis C together with the second shaft 61.

When the first impeller 2 and the second impeller 5 rotate, a stream of air flowing from the intake port 81 toward the discharge port 82 is generated by the plurality of first blades 21 and the plurality of second blades 51. That is, air is taken into the casing 8 through the intake port 81. The air taken into the casing 8 passes through the openings 9a between the circumferentially adjacent ribs 9 and flows toward the discharge port 82. The air reaching the discharge port 82 is discharged to the outside through the discharge port 82. Therefore, in the configuration of the present example embodiment, air can be blown in one direction from the intake port 81 to the discharge port 82.

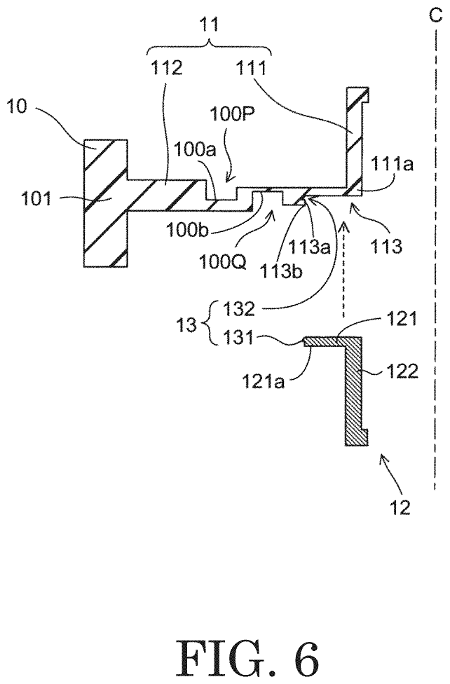

Next, the details of the first housing 11 and the second housing 12 will be described. FIG. 6 is an exploded sectional view of the first housing 11 and the second housing 12.

The first housing 11 has a cylindrical part 111 and a connection part 112. The cylindrical part 111 is formed to surround the central axis C. The inner diameter of the cylindrical part 111 is smaller than the inner diameter of the motor housing 10.

The connection part 112 connects the motor housing 10 and the cylindrical part 111 in the radial direction. More specifically, the connection part 112 radially connects a central part 101 located substantially at the center of the motor housing 10 in the axial direction and an axially lower end 111a which is on the lower side of the cylindrical part 111. Thus, the motor housing 10, the cylindrical part 111, and the connection part 112 are integrally formed. That is, the motor housing 10 and the first housing 11 are integrally formed.

The connection part 112 has a holding part 113 on the radially inner side. Here, the holding part 113 is formed as a recess upwardly recessed in the axial direction and having an annular shape as viewed from below in the axial direction, as shown in FIG. 4. The recess of the holding part 113 is formed into a shape conforming to the shape of a flange 121 described later of the second housing 12.

The second housing 12 has the flange 121 and a cylindrical part 122. The flange 121 is a thin plate having an annular shape when viewed from above in the axial direction. The cylindrical part 122 is connected to the flange 121 so as to extend downward in the axial direction.

The second housing 12 is held and fixed to the first housing 11 by inserting the flange 121 of the second housing 12 into the holding part 113 of the first housing 11 from below in the axial direction. That is, in the blower apparatus 1, the second housing 12 is fixed to the first housing 11. The second housing 12 is fixed by a snap-fit 13 so as not to be disengaged from the first housing 11, the detail of which will be described later.

The blower apparatus 1 according to the present example embodiment has a structure in which the second housing 12 is fixed to the first housing 11, and thus, the blower apparatus 1 can be assembled as follows. Specifically, the first bearing holding unit 35 is inserted into the first housing 11 from below in the axial direction, for example. Next, the first stator 33 with the first circuit board 4 is inserted into the casing 8 from above in the axial direction until the stator core 331 contacts the cylindrical part 111 of the first housing 11. Then, the first bearing holding unit 35 is press fitted into the radially inner side of the first stator 33, and the first bearing holding unit 35 is fixed to the first stator 33. Note that the first bearing holding unit 35 and the first stator 33 may be fixed using an adhesive agent.

Next, the first bearing 32, the first spring 36, and the first impeller 2 with the first shaft 31 are sequentially inserted into the casing 8 from above in the axial direction. Then, the first C retaining ring 37 is inserted into the casing 8 from below in the axial direction and attached to the first shaft 31. In this way, the attachment of the first impeller 2 and the first motor 3 to the inside of the casing 8 is completed.

On the other hand, the second stator 63, the second bearing holding unit 65, the second bearing 62, the second spring 66, and the second impeller 5 with the second shaft 61 are mounted to the second housing 12, and the second C retaining ring 67 is attached near the upper end of the second shaft 61 in the axial direction.

Next, the second housing 12 is attached to the first housing 11 from below in the axial direction. Thus, the attachment of the second impeller 5 and the second motor 6 to the inside of the casing 8 is completed, and the assembly of the blower apparatus 1 is completed.

As shown in FIG. 6, the first housing 11 has a dent part 132 in the holding part 113 described above. The dent part 132 is formed to be recessed radially outward from the inner surface 113a of the holding part 113. The dent part 132 is formed into a shape conforming to the shape of a protrusion 131 of the second housing 12.

The second housing 12 has the protrusion 131. The protrusion 131 is formed to protrude further outward in the radial direction from the radially outer end 121a of the flange 121 of the second housing 12.

When the second housing 12 is brought close to the first housing 11 from below in the axial direction, the protrusion 131 of the second housing 12 contacts a corner 113b of the holding part 113 of the first housing 11. When the second housing 12 is further pushed upward in the axial direction, a force for pushing the protrusion 131 radially inward is exerted due to a reaction force to the force applied to the corner 113b by the protrusion 131. As a result, the second housing 12 is slightly deformed such that the protrusion 131 moves to the inside of the holding part 113.

When the protrusion 131 reaches the dent part 132 due to the second housing 12 being further pushed upward in the axial direction, the force for pushing the protrusion 131 radially inward is released. Thus, the deformation of the second housing 12 is released, and the protrusion 131 fits into the dent part 132. As a result, the second housing 12 is prevented from being dislodged axially downwardly from the first housing 11, and is fixed to the first housing 11.

The structure in which the second housing 12 is fixed to the first housing 11 by the protrusion 131 being fitted into the dent part 132 in this manner is referred to as the snap-fit 13. That is, the second housing 12 is fixed to the first housing 11 by the snap-fit 13. In this case, since the first housing 11 and the second housing 12 can be easily fixed by the snap-fit 13, the assembly of the blower apparatus 1 is facilitated.

The method for fixing the second housing 12 and the first housing 11 is not limited to the above method using the snap-fit 13. For example, the second housing 12 and the first housing 11 may be fixed by screwing, may be fixed using a rivet, or may be fixed using an adhesive. However, from the viewpoint of further improving the ease of assembly, a fixing method using the snap-fit 13 as in the present example embodiment is desirable.

As shown in FIGS. 5 and 6, the first housing 11 has a first recessed portion 100P and a second recessed portion 100Q. The first recessed portion 100P is formed to be open at the upper side in the axial direction and to be closed at the lower side in the axial direction. Any of the mounted components 41 on the first circuit board 4 is inserted into the first recessed portion 100P from above in the axial direction.

Here, from among the mounted components 41, a component protruding to the side opposite to the stator core 331 from the first circuit board 4 (that is, protruding downward in the axial direction) can be considered to be inserted into the first recessed portion 100P. In particular, the binding pin which is tall in the axial direction can be considered to be one of the mounted components 41 which is to be inserted into the first recessed portion 100P. However, it is obvious that any other components such as a capacitor may be inserted into the first recessed portion 100P.

The number of first recessed portions 100P provided in the first housing 11 is not particularly limited. Further, the shape of the cross section of the first recessed portion 100P perpendicular to the axial direction is not particularly limited, and may be circular, elliptic, or polygonal. The number and the shape of the first recessed portions 100P may be appropriately set according to the number or shape of tall components among the mounted components 41 on the first circuit board 4.

The second recessed portion 100Q is formed to be open at the lower side in the axial direction and to be closed at the upper side in the axial direction. Any of the mounted components 71 on the second circuit board 7 is inserted into the second recessed portion 100Q from below in the axial direction. Here, from among the mounted components 71, a component protruding to the side opposite to the stator core 631 from the second circuit board 7 (that is, protruding upward in the axial direction) can be considered to be inserted into the second recessed portion 100Q. In particular, the binding pin which is tall in the axial direction can be considered to be one of the mounted components 71 which is to be inserted into the second recessed portion 100Q. However, it is obvious that any other components such as a capacitor may be inserted into the second recessed portion 100Q.

The number of second recessed portions 100Q provided in the first housing 11 is not particularly limited. Further, the shape of the cross section of the second recessed portion 100Q perpendicular to the axial direction is not particularly limited, and may be circular, elliptic, or polygonal. The number and the shape of the second recessed portions 100Q may be appropriately set according to the number or shape of tall components among the mounted components 71 on the second circuit board 7.

In the present example embodiment, both the first recessed portion 100P and the second recessed portion 100Q are formed in the first housing 11. However, as in a second example embodiment to be described later, only the first recessed portion 100P may be formed in the first housing 11, and only the second recessed portion 100Q may be formed in the second housing 12. Also, the first recessed portion 100P and the second recessed portion 100Q may be located to extend across the first housing 11 and the second housing 12. Furthermore, both the first recessed portion 100P and the second recessed portion 100Q may be formed in the second housing 12.

That is, the first housing 11 or the second housing 12 has the first recessed portion 100P which is open on one side in the axial direction and is closed on the another side in the axial direction and into which the mounted component 41 on the first circuit board 4 is inserted from one side in the axial direction, and the second recessed portion 100Q which is open on the another side in the axial direction and is closed on one side in the axial direction and into which the mounted component 71 on the second circuit board 7 is inserted from the another side in the axial direction.

In this configuration, the mounted component 41 mounted on the first circuit board 4 and protruding downward in the axial direction is inserted into the first recessed portion 100P in the casing 8. Further, the mounted component 71 mounted on the second circuit board 7 and protruding upward in the axial direction is inserted into the second recessed portion 100Q in the casing 8. As a result, even if the distance between the first circuit board and the second circuit board 7 in the axial direction is shortened, electrical insulation can be ensured. Therefore, the casing 8 can be entirely reduced in thickness in the axial direction by bringing the first impeller 2 and the second impeller 5 close to each other in the axial direction, whereby the blower apparatus 1 can be further reduced in thickness.

Further, the first recessed portion 100P and the second recessed portion 100Q are closed on the side opposite to the open side, so that they do not pass through the first housing 11 or the second housing 12. Therefore, the mounted component 41 on the first circuit board 4 and the mounted component 71 on the second circuit board 7 do not pass through the first housing 11 or the second housing 12, and thus, a long spatial distance between the mounted component 41 and the mounted component 71 can be ensured. As a result, there is no possibility that the mounted component 41 and the mounted component 71 contact each other in the axial direction via the first housing 11 or the second housing 12. Therefore, the abovementioned effect of reducing the thickness of the blower apparatus 1 with the interference between the mounted component 41 and the mounted component 71 being avoided can be obtained.

Conversely, when the axial distance between the first circuit board 4 and the second circuit board 7 is shortened in the case where the axial thickness of the casing 8 is constant, the space for accommodating the first motor 3 and the second motor 6 in the casing 8 is widened in the axial direction. As a result, it becomes possible to use the first motor 3 and the second motor 6 having high blowing capacity, whereby the volume of blowing air can be increased using the casing 8 of the same thickness.

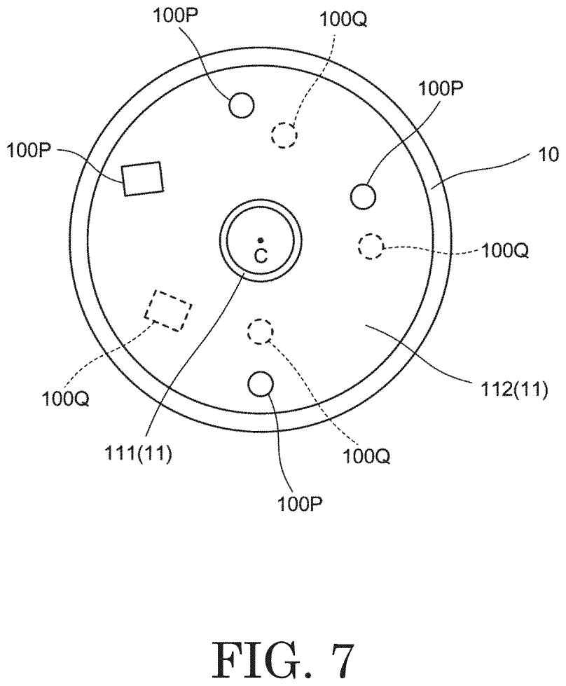

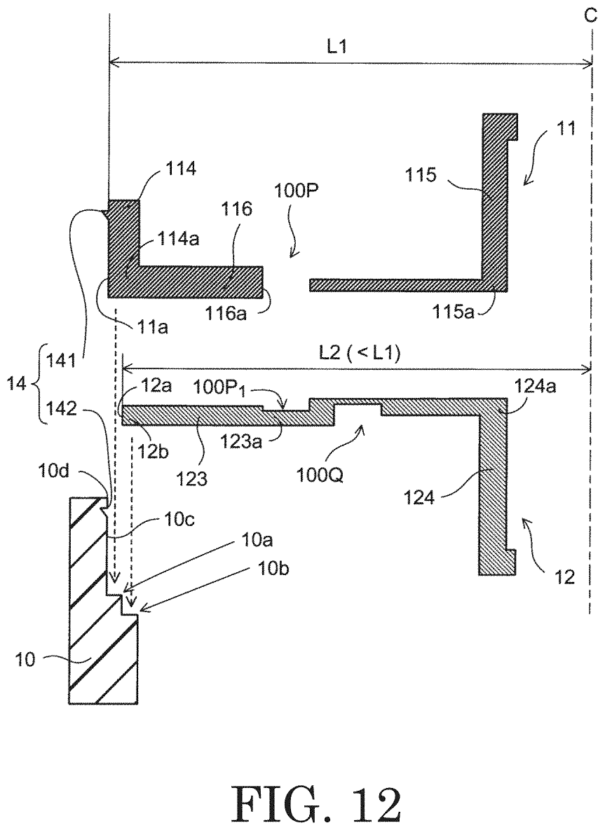

FIG. 7 is a plan view of the first housing 11 of the blower apparatus 1 according to the present example embodiment as viewed from the intake port 81 side. In the first housing 11, the first recessed portion 100P and the second recessed portion 100Q are offset from each other in at least one of the circumferential direction and the radial direction. Even in the configuration in which the first recessed portion 100P₁ and the second recessed portion 100Q are formed in the second housing 12 as in the configuration of the later-described second example embodiment shown in FIG. 12, the first recessed portion 100P₁ and the second recessed portion 100Q are offset from each other in at least one of the circumferential direction and the radial direction. The first recessed portion 100P₁ is a recessed portion included in the first recessed portion 100P, and can be considered to be functionally the same as the first recessed portion 100P.

That is, in the first housing 11 or the second housing 12, the first recessed portion 100P and the second recessed portion 100Q are offset from each other in at least one of the circumferential direction and the radial direction.

In this configuration, even if the thickness of the first housing 11 (particularly, the connection part 112) is further reduced in the axial direction, there is no chance that the first recessed portion 100P and the second recessed portion 100Q pass through the first housing 11 in the axial direction and are connected to each other. Therefore, the mounted component 41 inserted into the first recessed portion 100P and the mounted component 71 inserted into the second recessed portion 100Q do not interfere with each other in the axial direction, whereby electrical insulation between the mounted components 41 and 71 can be ensured. Accordingly, it is possible to further reduce the thickness of the first housing 11 in the axial direction with the necessary depths of the first recessed portion 100P and the second recessed portion 100Q being maintained.

As a result, the axial distance between the first circuit board 4 and the second circuit board 7 can be further shortened, whereby the axial distance between the first impeller 2 and the second impeller 5 can be further shortened. Consequently, it is possible to further reduce the thickness of the casing 8 and the blower apparatus 1. That is, it is possible to further reduce the thickness of the casing 8 and the blower apparatus 1 while avoiding the interference between the mounted component 41 and the mounted component 71. Even in the case where the first recessed portion 100P and the second recessed portion 100Q are offset from each other in at least one of the circumferential direction and the radial direction in the second housing 12, similar effects can be obtained for the same reason as described above.

Further, in the present example embodiment, an inner bottom surface 100a of the first recessed portion 100P is located further on the another side in the axial direction than an inner bottom surface 100b of the second recessed portion 100Q as shown in FIG. 6. The inner bottom surface 100a is a bottom surface included in the inner surface of the first recessed portion 100P and indicates a surface perpendicular to the central axis C. Similarly, the inner bottom surface 100b is a bottom surface included in the inner surface of the second recessed portion 100Q, and indicates a surface perpendicular to the central axis C.

In this configuration, the thickness of the first housing 11 (particularly, the connection part 112) in the axial direction can be further reduced with the depths of the first recessed portion 100P and the second recessed portion 100Q in the axial direction being ensured. Thus, the axial distance between the first circuit board 4 and the second circuit board 7 can be further decreased by inserting the mounted component 41 into the first recessed portion 100P and inserting the mounted component 71 into the second recessed portion 100Q. Consequently, it is possible to further reduce the thickness of the casing 8 and the blower apparatus 1.

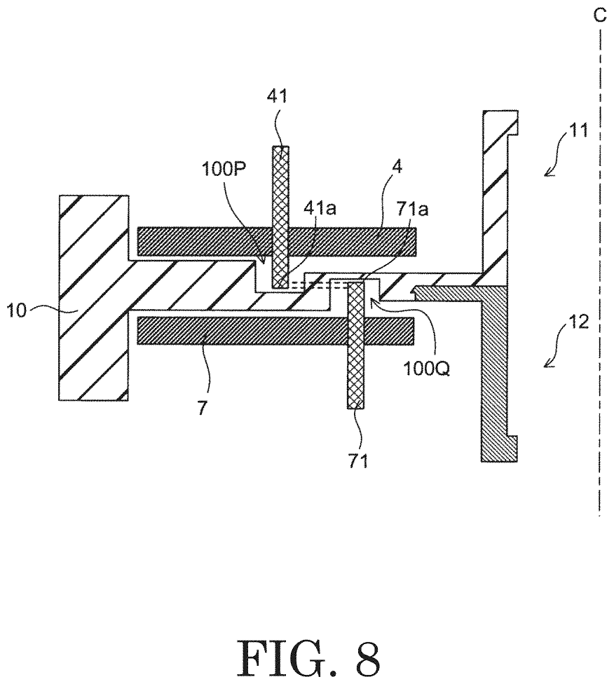

FIG. 8 is a sectional view showing a desired positional relationship between the first circuit board 4 and the second circuit board 7. In FIG. 8, a leading end 41a on the lower side in the axial direction of the mounted component 41 on the first circuit board 4 is located axially below a leading end 71a on the upper side in the axial direction of the mounted component 71 on the second circuit board 7. That is, when the mounted component 41 mounted on the first circuit board 4 and inserted into the first recessed portion 100P is defined as a first mounted component, and the mounted component 71 mounted on the second circuit board 7 and inserted into the second recessed portion 100Q is defined as a second mounted component, the leading end 41a on the another side of the first mounted component in the axial direction is located further on the another side in the axial direction than the leading end 71a on one side of the second mounted component in the axial direction.

In this configuration, the mounted component 41 on the first circuit board 4 and the mounted component 71 on the second circuit board 7 are deeply inserted into the first recessed portion 100P and the second recessed portion 100Q, respectively. Therefore, the axial distance between the first circuit board 4 and the second circuit board 7 can be further shortened. Accordingly, the axial distance between the first impeller 2 and the second impeller 5 can be further shortened. As a result, the casing 8 can be entirely reduced in thickness in the axial direction, whereby the thickness of the blower apparatus 1 can be further reduced.

As described above, in the present example embodiment, the first housing 11 is integrally formed with the motor housing 10, the second housing 12 is fixed to the first housing 11, and the first housing 11 has the first recessed portion 100P and the second recessed portion 100Q. Thus, in the configuration in which the second housing 12 is fixed to the first housing 11 which is integrally formed with the motor housing 10, and the first housing 11 has both the first recessed portion 100P and the second recessed portion 100Q, the abovementioned effect of reducing the thickness of the blower apparatus 1 can be obtained.

Another example embodiment of the present disclosure will be described in detail with reference to the accompanying drawings. In a blower apparatus 1 according to the present example embodiment, the configuration other than the motor housing 10, the first housing 11, and the second housing 12 is the same as that of the first example embodiment, and thus the description thereof will be omitted below.

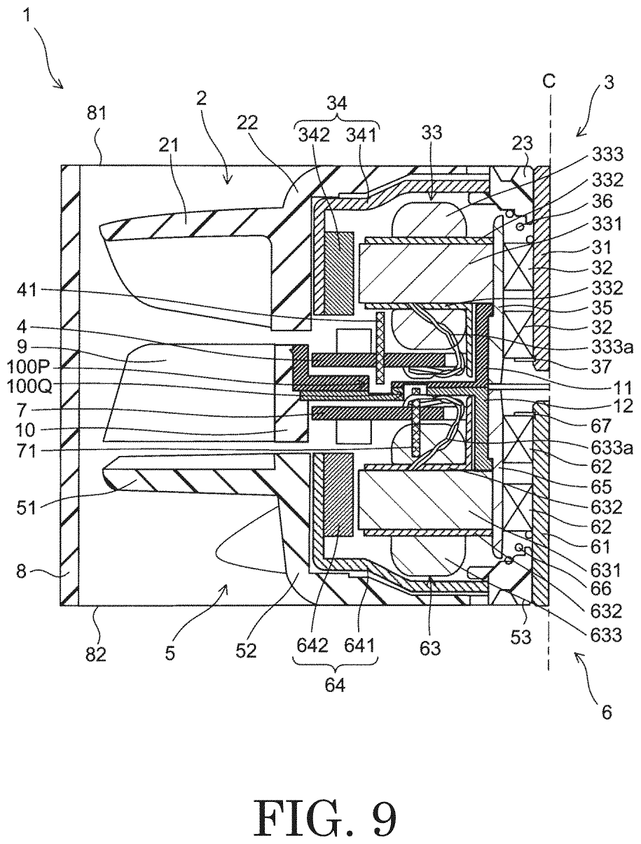

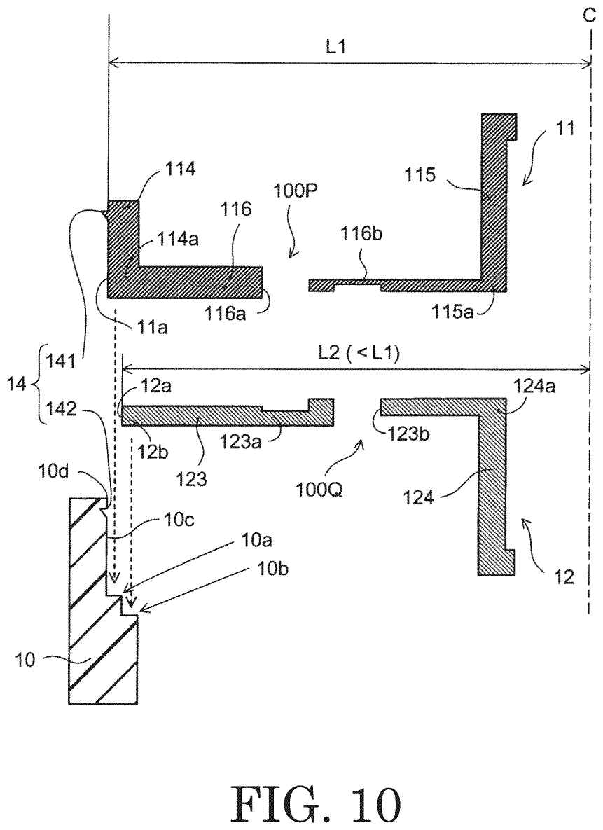

FIG. 9 is a longitudinal sectional view showing the blower apparatus 1 according to the present example embodiment. For convenience, FIG. 9 shows the cross section of only one side of the blower apparatus 1 in the radial direction with respect to the central axis C. FIG. 10 is an exploded sectional view of the motor housing 10, the first housing 11, and the second housing 12 of the blower apparatus 1 shown in FIG. 9. In the present example embodiment, the motor housing 10, the first housing 11, and the second housing 12 are different members.

In the present example embodiment, the first housing 11 and the second housing 12 are arranged in the axial direction. In particular, the first housing 11 is located above the second housing 12 in the axial direction. When a distance from the central axis C to an outer surface 11a which is a radially outer surface of the first housing 11 is defined as L1 (mm), and a distance from the central axis C to an outer surface 12a which is a radially outer surface of the second housing 12 is defined as L2 (mm), L2<L1 is established. That is, the outer surface 11a of the first housing 11 is located radially outward of the outer surface 12a of the second housing 12.

The first housing 11 has a large diameter part 114, a cylindrical part 115, and a connection part 116. The large diameter part 114 is the outermost part of the first housing 11 in the radial direction, and is formed to surround the connection part 116. The connection part 116 is formed to surround the cylindrical part 115. The cylindrical part 115 is formed to surround the central axis C.

The connection part 116 connects the large diameter part 114 and the cylindrical part 115 in the radial direction. More specifically, the connection part 116 radially connects a lower end 114a of the large diameter part 114 in the axial direction and a lower end 115a of the cylindrical part 115 in the axial direction. Thus, the first housing 11 in which the large diameter part 114, the cylindrical part 115, and the connection part 116 are integrated is configured.

The second housing 12 has a plate-shaped part 123 and a cylindrical part 124. The plate-shaped part 123 is a plate member extending radially outward from an upper end 124a of the cylindrical part 124 in the axial direction. The cylindrical part 124 is formed to surround the central axis C.

The first housing 11 is fixed to the first bearing holding unit 35 of the first motor 3, thereby supporting the first motor 3. The second housing 12 is fixed to the second bearing holding unit 65 of the second motor 6, thereby supporting the second motor 6.

The first housing 11 and the second housing 12 having the above-described configurations are fixed to the motor housing 10, and therefore, the motor housing 10 is slightly different from that shown in FIGS. 5 and 6.

The motor housing 10 has a first receiving part 10a and a second receiving part 10b. The first receiving part 10a is located radially inward of the plurality of ribs 9. The first receiving part 10a receives the first housing 11, which is inserted from above in the axial direction, at a position axially above and radially outward of the second receiving part 10b. The second receiving part 10b receives the second housing 12 which is inserted from above in the axial direction.

In the present example embodiment, the blower apparatus 1 can be assembled as follows. First, the second stator 63 with the second circuit board 7, the second bearing holding unit 65, and the second bearing 62 are attached to the second housing 12 outside the casing 8. Then, the second housing 12 is inserted into the casing 8 from above in the axial direction. Thereafter, the second spring 66 and the second impeller 5 with the second shaft 61 are sequentially inserted from below in the axial direction, and the second C retaining ring 67 is attached in the vicinity of the axially upper end of the second shaft 61.

Next, the first stator 33 with the first circuit board 4, the first bearing holding unit 35, the first bearing 32, the first spring 36, the first impeller 2 with the first shaft 31, and the first C retaining ring 37 are sequentially attached to the first housing 11 outside the casing 8. Thereafter, the first housing 11 is inserted into the casing 8 from above in the axial direction and fixed. Thus, the blower apparatus 1 is completed.

As shown in FIG. 10, the first housing 11 has a protrusion 141. The protrusion 141 is formed to protrude radially outward from the outer surface 11a of the first housing 11. The motor housing 10 also has a dent part 142. The dent part 142 is formed to be recessed radially outward from the inner surface 10c of the motor housing 10. The inner surface 10c of the motor housing 10 is located above the first receiving part 10a in the axial direction. The inner surface 10c contacts the outer surface 11a of the first housing 11, by which the first housing 11 slides in the axial direction. The dent part 142 is formed into a shape conforming to the shape of the protrusion 141 of the first housing 11.

When the first housing 11 is moved downward in the axial direction, the protrusion 141 of the first housing 11 comes in contact with the corner 10d of the motor housing 10. When the first housing 11 is further pushed downward in the axial direction, a force for pushing the protrusion 141 radially inward is exerted due to a reaction force to the force applied to the corner 10d by the protrusion 141. As a result, the first housing 11 is slightly deformed such that the protrusion 141 moves toward the radially inner side of the motor housing 10.

When the protrusion 141 reaches the dent part 142 due to the first housing 11 being further pushed downward in the axial direction, the force for pushing the protrusion 141 radially inward with respect to the dent part 142 is released. Thus, the deformation of the first housing 11 is released, and the protrusion 141 fits into the dent part 142. As a result, the first housing is prevented from being dislodged upwardly from the motor housing 10 in the axial direction, and is fixed to the motor housing 10.

The structure in which the first housing 11 is fixed to the motor housing 10 by the protrusion 141 being fitted into the dent part 142 in this manner is referred to as a snap-fit 14. That is, the first housing 11 is fixed to the motor housing 10 by the snap-fit 14. Since the first housing 11 and the motor housing 10 can be easily fixed by the snap-fit 14, the assembly of the blower apparatus 1 is facilitated.

The method for fixing the first housing 11 and the motor housing 10 is not limited to the above method using the snap-fit 14. That is, the first housing 11 and the motor housing 10 may be fixed by screwing, may be fixed using a rivet, or may be fixed using an adhesive. However, from the viewpoint of further improving the ease of assembly, a fixing method using the snap-fit 14 is desirable.

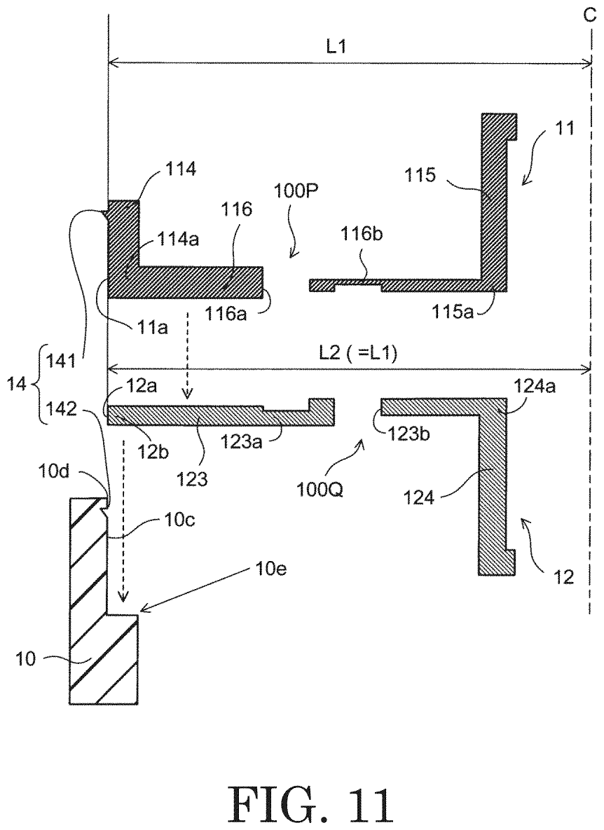

FIG. 11 is an exploded sectional view showing another configuration of the motor housing 10 and the second housing 12. In the configuration shown in FIG. 11, when the distance from the central axis C to the outer surface 11a of the first housing 11 is defined as L1 (mm), and the distance, that is, the radial length, from the central axis C to the outer surface 12a of the second housing 12 is defined as L2 (mm), L2=L1 is established. That is, the outer surface 11a of the first housing 11 is located at the same position as the outer surface 12a of the second housing 12 in the radial direction.

Further, the motor housing 10 has a housing receiving part 10e. The housing receiving part 10e is located radially inward of the plurality of ribs 9. The housing receiving part 10e simultaneously receives the first housing 11 and the second housing 12 which are inserted from above in the axial direction.

When the radial lengths of the first housing 11 and the second housing 12 are the same, both the first housing 11 and the second housing 12 of the motor housing 10 can be received by the single housing receiving part 10e in the axial direction. Therefore, it is not necessary to provide different receiving parts for individually receiving the first housing 11 and the second housing 12 to the motor housing 10, as shown in FIG. 10. In other words, it is only sufficient that only one receiving part which is the minimum necessary is provided. Therefore, the configuration of the motor housing 10 can be simplified as compared with the configuration in FIG. 10.

As shown in FIGS. 9 to 11, in the blower apparatus 1 according to the present example embodiment in which the first housing 11 and the second housing 12 are arranged in the axial direction, at least one of the first recessed portion 100P and the second recessed portion 100Q are provided to extend across the first housing 11 and the second housing 12. In particular, in the present example embodiment, both the first recessed portion 100P and the second recessed portion 100Q are located to extend across the first housing 11 and the second housing 12.

The first recessed portion 100P has a through hole 116a and a lid portion 123a. The through hole 116a is a hole that axially penetrates the connection part 116 of the first housing 11 which is located on the upper side in the axial direction, from among the first housing 11 and the second housing 12. The lid portion 123a is located in the second housing 12 which is located on the lower side in the axial direction, from among the first housing 11 and the second housing 12, and closes the through hole 116a. The lid portion 123a is constituted by a portion of the plate-shaped part 123 of the second housing 12.

That is, the first recessed portion 100P has the through hole 116a that axially penetrates the first housing 11 on one side in the axial direction, and the lid portion 123a which is located on the second housing 12 on the another side in the axial direction and which closes the through hole 116a. With this configuration, even if the first housing 11 and the second housing 12 are arranged in the axial direction, it is possible to provide the first recessed portion 100P which is open on one side in the axial direction and which is closed on the another side in the axial direction.

The second recessed portion 100Q has a through hole 123b and a lid portion 116b. The through hole 123b is a hole that axially penetrates the plate-shaped part 123 of the second housing 12 which is on the lower side in the axial direction, from among the first housing 11 and the second housing 12. The lid portion 116b is located in the first housing 11 which is located on the upper side in the axial direction, from among the first housing 11 and the second housing 12, and closes the through hole 123b. The lid portion 116b is constituted by a portion of the connection part 116 of the first housing 11.

That is, the second recessed portion 100Q has the through hole 123b that axially penetrates the second housing 12 on the another side in the axial direction, and the lid portion 116b which is located on the first housing 11 on one side in the axial direction and which closes the through hole 123b. With this configuration, even if the first housing 11 and the second housing 12 are arranged in the axial direction, it is possible to provide the second recessed portion 100Q which is open on the another side in the axial direction and which is closed on one side in the axial direction.

A mounted component 41 mounted on the first circuit board 4 and protruding downward in the axial direction is inserted into the first recessed portion 100P from above in the axial direction. Further, a mounted component 71 mounted on the second circuit board 7 and protruding upward in the axial direction is inserted into the second recessed portion 100Q from below in the axial direction in the casing 8. Therefore, as in the first example embodiment, the axial distance between the first circuit board 4 and the second circuit board 7 can be shortened, whereby the casing 8 and the blower apparatus 1 can be reduced in thickness. Further, the first recessed portion 100P and the second recessed portion 100Q are closed on the side opposite to the open side, so that they do not pass through the first housing 11 or the second housing 12. For this reason, the effect of reducing the thickness of the blower apparatus 1 while avoiding the interference between the mounted component 41 inserted into the first recessed portion 100P and the mounted component 71 inserted into the second recessed portion 100Q can be obtained.

Further, when at least one of the first recessed portion 100P and the second recessed portion 100Q is provided to extend across the first housing 11 and the second housing 12, the first recessed portion 100P and the second recessed portion 100Q can be formed deep in the axial direction. Thus, the mounted component 41 of the first circuit board 4 can be deeply inserted into the first recessed portion 100P. Also, the mounted component 71 of the second circuit board 7 can be deeply inserted into the second recessed portion 100Q. As a result, the axial distance between the first circuit board 4 and the second circuit board 7 can be further shortened, whereby the casing 8 and the blower apparatus 1 can be further reduced in thickness.

Meanwhile, the lid portion 123a may have any shape that can close the through hole 116a, and may have a flat plate shape. Similarly, the lid portion 116b may have any shape that can close the through hole 123b, and may have a flat plate shape.

It is to be noted, however, that at least one of the lid portion 123a and the lid portion 116b desirably has a recessed shape which is open on the upper side in the axial direction or on the lower side in the axial direction. In the present example embodiment, the lid portion 123a and the lid portion 116b both have a recessed shape, as shown in FIGS. 10 and 11.

That is, the lid portion 123a has a recessed shape which is open on the through hole 116a side. The lid portion 116b has a recessed shape which is open on the through hole 123b side. When the lid portion 123a and the lid portion 116b have a recessed shape as described above, the first recessed portion 100P and the second recessed portion 100Q can be formed deeper in the axial direction as compared with the case where they have a flat plate shape. Thus, the axial distance between the first circuit board 4 and the second circuit board 7 can be further decreased by inserting the mounted component 41 deeply into the first recessed portion 100P and inserting the mounted component 71 deeply into the second recessed portion 100Q. As a result, the axial distance between the first impeller 2 and the second impeller 5 can be decreased, whereby the thickness of the casing 8 and the blower apparatus 1 can be further reduced.

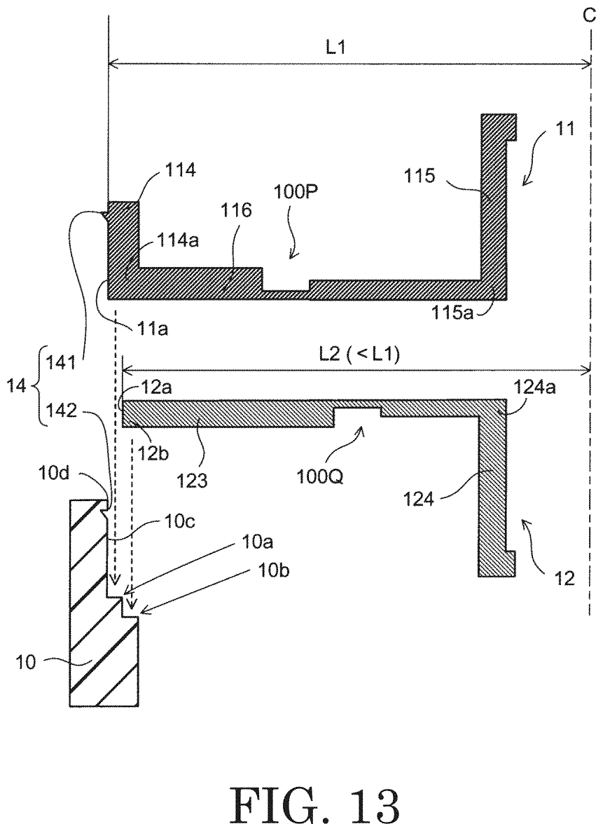

FIGS. 12 and 13 are exploded sectional views showing another configuration of the first housing 11 and the second housing 12. Here, a recessed portion formed when the lid portion 123a of the second housing 12 has a recessed shape which is open on the upper side in the axial direction is referred to as a first recessed portion 100P₁. The first recessed portion 100P₁ is common to the first recessed portion 100P described above in that it is open on the upper side in the axial direction, is closed on the lower side in the axial direction, and receives the mounted component 41 on the first circuit board 4 which is inserted from above in the axial direction. That is, the first recessed portion 100P includes the first recessed portion 100P₁.

As shown in FIG. 12, the first recessed portion 100P₁ may be located to extend across the first housing 11 and the second housing 12, and the second recessed portion 100Q may be located only in the second housing 12. Note that the second recessed portion 100Q may be located to extend across the first housing 11 and the second housing 12, and the first recessed portion 100P may be located only in the first housing 11. Further, as shown in FIG. 13, the first recessed portion 100P may be located only in the first housing 11, and the second recessed portion 100Q may be located only in the second housing 12.

Even in the configurations shown in FIG. 12 and FIG. 13, the mounted component 41 on the first circuit board 4 is inserted into the first recessed portion 100P. Further, the mounted component 71 on the second circuit board 7 is inserted into the second recessed portion 100Q. Therefore, the axial distance between the first circuit board 4 and the second circuit board 7 can be shortened, whereby the casing 8 and the blower apparatus 1 can be reduced in thickness.

Moreover, in the blower apparatus 1 according to the present example embodiment, the first recessed portion 100P and the second recessed portion 100Q are also offset from each other in at least one of the circumferential direction and radial direction as shown in FIGS. 9 to 13. Thus, at least one of the first housing 11 and the second housing 12 can be reduced in thickness, while electrical insulation between the mounted component 41 and the mounted component 71 is ensured. As a result, as in the first example embodiment, it is possible to reduce the thickness of the casing 8 and the blower apparatus 1 while avoiding interference between the mounted component 41 and the mounted component 71.

Note that the configurations described in the first example embodiment can be combined with the present example embodiment. For example, the bottom surface of the first recessed portion 100P on the another side in the axial direction may be located further on the another side in the axial direction than the bottom surface of the second recessed portion 100Q on one side in the axial direction. Further, the leading end on the another side in the axial direction of the mounted component 41 which is on the first circuit board 4 and which is inserted into the first recessed portion 100P may be located further on the another side in the axial direction than the leading end on one side in the axial direction of the mounted component 71 which is on the second circuit board 7 and is inserted into the second recessed portion 100Q.

While example embodiments of the present disclosure have been described above, it will be understood that the scope of the present disclosure is not limited to the above-described example embodiments, and that various modifications are possible without departing from the spirit of the present disclosure. In addition, features of the above-described example embodiments and the modifications thereof may be combined appropriately as desired.

The blower apparatus according to the present disclosure is applicable to serial axial blowing apparatuses.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A blower apparatus comprising:
a first impeller and a second impeller that are arranged in an axial direction;
a first motor located closer to the second impeller than to the first impeller to rotate the first impeller around a central axis;
a first circuit board provided closer to the second impeller than to the first impeller on the first motor;
a second motor located closer to the first impeller than to the second impeller to rotate the second impeller around the central axis;
a second circuit board provided closer to the first impeller than to the second impeller on the second motor;
a casing that houses the first impeller, the first motor, the first circuit board, the second impeller, the second motor, and the second circuit board;
a motor housing that is located between the first impeller and the second impeller in the casing, is located radially inward of the casing, and is integrally provided with the casing;
a first housing that supports the first motor on a first side in the axial direction of the motor housing; and
a second housing that supports the second motor on a second side in the axial direction of the motor housing; wherein
the first housing or the second housing includes:
a first recessed portion which is open on the first side in the axial direction, which is closed on the second side in the axial direction, and into which a mounted component on the first circuit board is inserted from the first side in the axial direction; and
a second recessed portion which is open on the second side in the axial direction, which is closed on the first side in the axial direction, and into which a mounted component on the second circuit board is inserted from the second side in the axial direction; and
the first recessed portion and the second recessed portion are offset from each other in at least one of a circumferential direction and a radial direction in the first housing or the second housing.

2. The blower apparatus according to claim 1, wherein an inner bottom surface of the first recessed portion is located farther on the second side in the axial direction than on an inner bottom surface of the second recessed portion.

3. The blower apparatus according to claim 2, wherein
when the mounted component mounted on the first circuit board and inserted into the first recessed portion is a first mounted component, and the mounted component mounted on the second circuit board and inserted into the second recessed portion is a second mounted component:
a leading end on the second side in the axial direction of the first mounted component is located farther on the second side in the axial direction than a leading end on the first side in the axial direction of the second mounted component.

4. The blower apparatus according to claim 1, wherein
the first housing is integrally provided together with the motor housing to define a single monolithic member;
the second housing is fixed to the first housing; and
the first housing includes the first recessed portion and the second recessed portion.

5. The blower apparatus according to claim 1, wherein
the first housing and the second housing are arranged in the axial direction; and
at least one of the first recessed portion and the second recessed portion extends across the first housing and the second housing.

6. The blower apparatus according to claim 5, wherein
the first recessed portion includes:
a through hole that axially penetrates the first housing on the first side in the axial direction; and
a lid portion that is located on the second housing on the second side in the axial direction and that closes the through hole.

7. The blower apparatus according to claim 5, wherein
the second recessed portion includes:
a through hole that axially penetrates the second housing on the second side in the axial direction; and
a lid portion that is located on the first housing on the first side in the axial direction and that closes the through hole.

8. The blower apparatus according to claim 6, wherein the lid portion has a recessed shape which is open on a side of the through hole.
